(19) United States
(12) Patent Application Publication
(10) Pub. No.: US 2009/0257560 A1
(43) Pub. Date: Oct. 15, 2009

(54) 3D POLY-PHASE TRANSFORMER

(75) Inventors: Oscar Khutoryansky, Baldwinsville, NY (US); Thomas William Rosevear, Liverpool, NY (US)

Correspondence Address: Hiscock & Barclay, LLP, One Park Place, 300 South State Street, Syracuse, NY, 13202-2078, US

(73) Assignee: INFIMED, INC., Liverpool, NY (US)

(21) Appl. No.: 12/275,679

(22) Filed: Nov. 21, 2008

Related U.S. Application Data
(60) Provisional application No. 61/044,770, filed on Apr. 14, 2008.

(51) Int. Cl. H05G 1/10; H01F 30/12; H01F 41/00

(52) U.S. Cl. 378/101; 336/5; 29/606

(57) ABSTRACT

A three dimensional (3D) poly-phase transformer includes a plurality of transformer ribs mechanically and magnetically coupled such that each transformer rib forms a leg of a polygon. A plurality of the polygons forms a 3D polyhedron structure. At least two base planes of the 3D poly-phase transformer including a polygon have a plurality of base ribs. At least four side ribs of the 3D poly-phase transformer are disposed between the base planes. The 3D poly-phase transformer includes a plurality of primary and secondary transformer windings. Another 3D poly-phase transformer includes at least two base planes having a closed curve. Each closed curve includes a plurality of curved base ribs, and at least four side ribs of the 3D poly-phase transformer disposed between the base planes. Methods of manufacturing three dimensional (3D) poly-phase transformers are also described.

### CROSS-REFERENCE TO RELATED APPLICATIONS

This application claims priority to and the benefit of co-pending U.S. provisional patent application Ser. No. 61/044,770, filed Apr. 14, 2008 entitled “3D POLY-PHASE TRANSFORMER”, incorporated herein by reference in its entirety.

### FIELD OF THE INVENTION

This invention relates generally to a poly-phase transformer and more particularly to a three dimensional poly-phase transformer.

### BACKGROUND OF THE INVENTION

Electrical transformers are used to transfer and transform alternating current, typically from at least one primary winding to at least one secondary winding. The transformation aspect includes the ability of a transformer to create a higher or lower output voltage at the output of a secondary winding as compared to the input voltage at a primary winding. The fundamental principle behind energy transfer across a transformer is that an AC current in one or more primary windings creates a magnetic flux in a transformer core typically having one or more magnetic paths. One or more secondary windings wound over a magnetic path having magnetic flux created by the primary winding. The one or more secondary windings extract electrical energy as changing (AC) magnetic flux lines induce an electrical current into the secondary winding, creating a secondary voltage.

Most types of transformers also create a break in ground connections called a galvanic break or galvanic isolation. The galvanic break creates an electrical isolation between the primary winding and the secondary windings. In many cases the secondary windings are also isolated from each other, that is, without having a common ground connection. The galvanic break can be important in some applications for safety reasons. The galvanic break can also be important where there is more than one secondary winding and where direct current (DC) voltages created on the secondary side of the transformer are combined in series connections.

In more advanced transformer applications, more than one phase of AC voltage can be transmitted across the transformer break. Typically, individual primary windings are powered by different phases. Three phase transformers, for example, are well known and commonly used in high power applications such as to power commercial office buildings and industrial factories.

Many transformers have more than one magnetic path. Generally, each magnetic path includes one or more sections of magnetic material to form a magnetic “leg”, typically in the shape of a bar or cylinder. The legs can be mechanically configured to create various known transformer geometries, including, for example, “C” and “E” shaped cores which reside in a common plane.

In some applications, more than one transformer can be combined in an electrical circuit to achieve certain desired electrical characteristics. Each of the combined transformers can, for example, be a simple transformer with a single primary or secondary winding. One problem is that present types of transformers have relatively large physical sizes and therefore require large physical spaces to be dedicated for their presence.

What is needed is an efficient multi-phase transformer that occupies less space and has reduced electrical loss.

### SUMMARY OF THE INVENTION

According to one aspect, a three dimensional (3D) poly-phase transformer includes a plurality of transformer ribs mechanically and magnetically coupled such that each transformer rib forms a leg of a polygon. A plurality of the polygons forms a 3D polyhedron structure. At least two base planes of the 3D poly-phase transformer including a polygon have a plurality of base ribs. At least four side ribs of the 3D poly-phase transformer are disposed between the base planes. The three dimensional (3D) poly-phase transformer also includes a plurality of primary transformer windings. Each of the primary transformer windings are electromagnetically coupled to at least one rib of the plurality of transformer ribs. The three dimensional (3D) poly-phase transformer also includes a plurality of secondary transformer windings. Each of the secondary transformer windings are electromagnetically coupled to at least one rib of the plurality of transformer ribs, wherein, each of the primary transformer windings is configured to be powered by a phase of a primary poly-phase source of electrical power and each of the secondary transformer windings is configured to provide a secondary source of electrical power at a corresponding phase.

In one embodiment, the 3D poly-phase transformer includes an odd number of the transformer ribs.

In another embodiment at least one of the at least two base planes of the 3D poly-phase transformer includes an odd number of the base ribs.

In yet another embodiment at least one of the polygons includes a pentagon.

In yet another embodiment the polyhedron structure includes a pentagon prism.

In yet another embodiment at least one of the side ribs includes a substantially straight side rib.

In yet another embodiment at least one of the side ribs includes a curved side rib.

In yet another embodiment the plurality of primary transformer windings and the plurality of secondary transformer windings are exclusively disposed on base ribs.

In yet another embodiment the 3D poly-phase transformer includes three or more base planes, at least one of the three or more base planes including at least one curved section.

In yet another embodiment the plurality of primary transformer windings are energized in a magnetic sequence pattern wherein a magnetic flux is alternately switched from a base rib in one of the at least two base planes to a base rib in another base plane.

In yet another embodiment a successive base rib in a rotation direction is magnetically energized on switching to each base plane.

In yet another embodiment an x-ray imaging apparatus for imaging a physiological structure includes an x-ray generator including a three dimensional 3D poly-phase transformer. The x-ray imaging apparatus also includes a source of x-rays powered by the x-ray generator and configured to transmit x-rays through the physiological structure. The x-ray imaging apparatus also includes at least one digital detector system configured to detect x-rays emerging from the physiological structure. The x-ray imaging apparatus also includes a processor configured to receive an output signal from the at least one digital detector, wherein the output signal can be processed to generate imaging data representative of the physiological structure.

In yet another embodiment the power supply includes a pulsed power mode for stroboscopic imaging applications.

In yet another embodiment the stroboscopic imaging including synchronization to a physiological parameter.

In yet another embodiment an x-ray imaging apparatus for imaging a physiological structure includes an x-ray generator including a three dimensional 3D poly-phase transformer. The x-ray imaging apparatus also includes a source of x-rays powered by the x-ray generator and configured to transmit x-rays through the physiological structure. The x-ray imaging apparatus also includes at least one film based detector system configured to detect x-rays emerging from the physiological structure, wherein the film can be photographically processed to generate imaging data representative of the physiological structure.

In yet another embodiment an x-ray generator for powering an x-ray source includes a 3D poly-phase transformer. The 3D poly-phase transformer is configured to accept electrical power from a source of electrical power. The x-ray generator also includes a rectifier circuit configured to rectify the secondary source of electrical power generated by the secondary transformer windings to generate an output voltage, wherein the output voltage powers the x-ray source.

According to another aspect, a three dimensional 3D poly-phase transformer includes a plurality of transformer ribs mechanically and magnetically coupled to form a 3D structure. At least two base planes of the 3D poly-phase transformer include a closed curve. The closed curve includes a plurality of curved base ribs, and at least four side ribs of the 3D poly-phase transformer disposed between the base planes. The three dimensional (3D) poly-phase transformer also includes a plurality of primary transformer windings, each of the primary transformer windings electro-magnetically coupled to at least one rib of the plurality of magnetic transformer ribs. The three dimensional (3D) poly-phase transformer also includes a plurality of secondary transformer windings, each of the secondary transformer windings electro-magnetically coupled to at least one rib of the plurality of magnetic transformer ribs, wherein, each of the primary transformer windings is configured to be powered by a phase of a primary poly-phase source of electrical power and each of the secondary transformer windings is configured to provide a secondary source of electrical power at a corresponding phase.

In one embodiment, the closed curve of at least one of the at least two base planes includes a circle.

In another embodiment, the closed curve of at least one of the at least two base planes includes an ellipse.

In yet another embodiment, the 3D poly-phase transformer includes an odd number of the transformer ribs.

In yet another embodiment, at least one of the at least two base planes of the 3D poly-phase transformer includes an odd number of the transformer base ribs.

In yet another embodiment, the at least one side leg of the 3D poly-phase transformer includes a substantially straight leg.

In yet another embodiment, the at least one side leg of the 3D poly-phase transformer includes a curved leg.

In yet another embodiment, the 3D poly-phase transformer includes three or more base planes, at least one of the three or more base planes including at least one substantially straight section.

In yet another embodiment the plurality of primary transformer windings are energized in a magnetic sequence pattern wherein a magnetic flux is alternately switched from a base rib in one of the at least two base planes to a base rib in another base plane.

In yet another embodiment a successive base rib in a rotation direction is magnetically energized on switching to each base plane.

In yet another embodiment, an x-ray imaging apparatus for imaging a physiological structure includes an x-ray generator including a three dimensional 3D poly-phase transformer. The x-ray imaging apparatus also includes a source of x-rays powered by the x-ray generator and configured to transmit x-rays through the physiological structure. The x-ray imaging apparatus also includes at least one digital detector system configured to detect x-rays emerging from the physiological structure. The x-ray imaging apparatus also includes a processor configured to receive an output signal from the at least one digital detector, wherein the output signal can be processed to generate imaging data representative of the physiological structure.

In yet another embodiment, the power supply includes a pulsed power mode for stroboscopic imaging applications.

In yet another embodiment, the stroboscopic imaging including synchronization to a physiological parameter.

In yet another embodiment an x-ray imaging apparatus for imaging a physiological structure includes an x-ray generator including a three dimensional 3D poly-phase transformer. The x-ray imaging apparatus also includes a source of x-rays powered by the x-ray generator and configured to transmit x-rays through the physiological structure. The x-ray imaging apparatus also includes at least one film based detector system configured to detect x-rays emerging from the physiological structure, wherein the film can be photographically processed to generate imaging data representative of the physiological structure.

In yet another embodiment an x-ray generator for powering an x-ray source includes a 3D poly-phase transformer. The 3D poly-phase transformer is configured to accept electrical power from a source. The x-ray generator also includes a rectifier circuit configured to rectify the secondary source of electrical power generated by the secondary transformer windings to generate an output voltage, wherein the output voltage powers the x-ray source.

According to another aspect, a method of manufacture of a three dimensional (3D) poly-phase transformer includes the steps of: forming a section of a polygon in a magnetic material; placing primary and secondary windings on at least one rib of the formed section of a polygon; and assembling the formed sections together to create a three 3D poly-phase transformer including at least two base planes having base ribs and at least 4 side ribs connecting the at least two base planes.

In one embodiment, the step of forming includes forming by molding a section of a polygon in a magnetic material.

In another embodiment, the step of forming includes forming a section of a polygon in a ferrite magnetic material.

In yet another embodiment, the step of assembling further includes assembling the formed sections together by gluing.

In yet another embodiment, the step of assembling further includes assembling the formed sections together by gluing using a glue having a magnetic permeability of greater than 1.

In yet another embodiment, the step of assembling further comprises assembling the formed sections together by mechanical straps.

In yet another embodiment, the step of assembling further comprises assembling the formed sections together by mechanical brackets.

In yet another embodiment, the step of placing includes placing primary and secondary windings on at least one rib at least one wound bobbin.

According to another aspect, a method of manufacture of a three dimensional (3D) poly-phase transformer includes the steps of: forming a section of a closed curve in a magnetic material; placing primary and secondary windings on at least one rib of the formed section of a closed curve; and assembling the formed sections together to create a 3D poly-phase transformer including at least two base planes having base ribs and at least 4 side ribs connecting the at least two base planes.

In one embodiment, the step of forming includes forming by molding a section of a closed curve in a magnetic material.

In another embodiment, the step of forming includes forming a section of a closed curve in a ferrite magnetic material.

In yet another embodiment, the step of assembling further includes assembling the formed sections together by gluing.

In yet another embodiment, the step of assembling further includes assembling the formed sections together by gluing using a glue having a magnetic permeability of greater than 1.

In yet another embodiment, the step of assembling further comprises assembling the formed sections together by mechanical straps.

In yet another embodiment, the step of assembling further comprises assembling the formed sections together by mechanical brackets.

In yet another embodiment, the step of placing includes placing primary and secondary windings on at least one rib using at least one wound bobbin.

### BRIEF DESCRIPTION OF THE DRAWINGS

For a further understanding of these and other described features, reference will be made to the following Detailed Description which is to be read in connection with the accompanying drawings, in which:

FIG. 1 shows a perspective view of a simplified stick figure representing one exemplary embodiment of a 3D poly-phase transformer;

FIG. 2 shows a perspective view of an exemplary pentagon prism 3D poly-phase transformer core;

FIG. 3 illustrates an exemplary pentagon prism core;

FIG. 4 shows another symbolic representation of an exemplary pentagon prism transformer;

FIG. 5 is a line diagram of an exemplary pentagon prism 3D poly-phase transformer showing its two base planes, base ribs, and side ribs;

FIG. 6 shows a perspective view of an exemplary pentagon prism 3D poly-phase transformer;

FIG. 7 shows an illustration of an exemplary 3D poly-phase transformer secondary coil;

FIG. 8 shows a perspective view of an exemplary closed curve (circle) 3D poly-phase transformer;

FIG. 9 illustrates one exemplary electrical primary and secondary winding configuration;

FIG. 10 illustrates another exemplary electrical primary and secondary winding configuration;

FIG. 11 shows one exemplary “U” structure for forming the magnetic core of a 3D poly-phase transformer;

FIG. 12 shows another exemplary structure for forming the magnetic core of a 3D poly-phase transformer;

FIG. 13 shows a perspective view of suitable component shapes for a pentagon 3D poly-phase transformer;

FIG. 14 shows a graph of a full wave rectified waveform;

FIG. 15 shows a graph of a three wave full wave rectified waveform drawn over a three phase sinusoid;

FIG. 16 shows a graph of 10 pulse ripple drawn over a graph of 10 sinusoids;

FIG. 17 shows an oscilloscope screen capture (oscillogram) of a kilovolt high voltage pulse produced using a two phase configuration;

FIG. 18 shows a view of the oscillogram of FIG. 17 magnified in time (2 μs/division);

FIG. 19 shows a HV (high voltage) pulse generated using three phases;

FIG. 20 shows a magnified view of the oscillogram of FIG. 19;

FIG. 21 shows an oscillogram of a HV pulse generated using four phases;

FIG. 22 shows a magnified view of the oscillogram of FIG. 21;

FIG. 23 shows an oscillogram of a HV pulse generated using eight phases;

FIG. 24 shows a magnified view of the oscillogram of FIG. 23;

FIG. 25 shows a block diagram of one exemplary embodiment of a power supply using a 3D poly-phase transformer;

FIG. 26 shows one exemplary phase timing diagram of phases suitable for use to drive the exemplary power supply of FIG. 25;

FIG. 27 shows an exemplary phase timing diagram using PWM (pulse width modulation) control to the power supply of FIG. 25;

FIG. 28 shows exemplary waveforms illustrating 10 phases of secondary side DC output ripple for each phase and the resultant low ripple sum of the 10 DC phase voltages;

FIG. 29 illustrates one an exemplary magnetic flux pattern; and

FIG. 30 shows an illustration of an exemplary of a polygon prism 3D poly-phase transformer package.

It should be noted that the drawings are not necessarily to scale, emphasis instead generally being placed upon illustrating the principles of the invention described herein. In the drawings, like numerals are used to indicate like parts throughout the various views for purposes of clarity.

### DETAILED DESCRIPTION

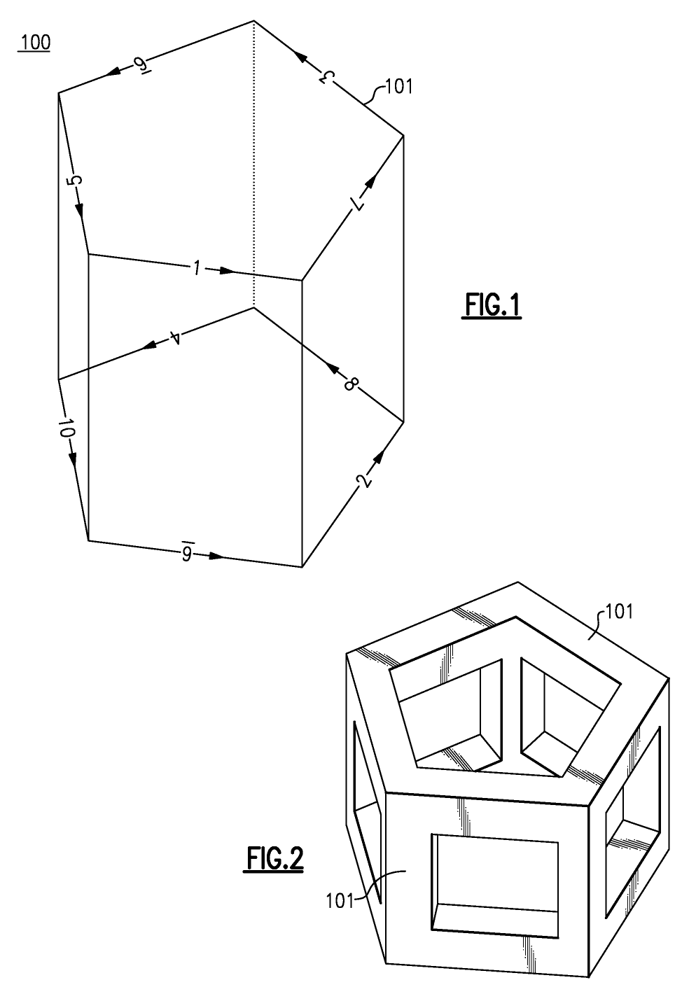

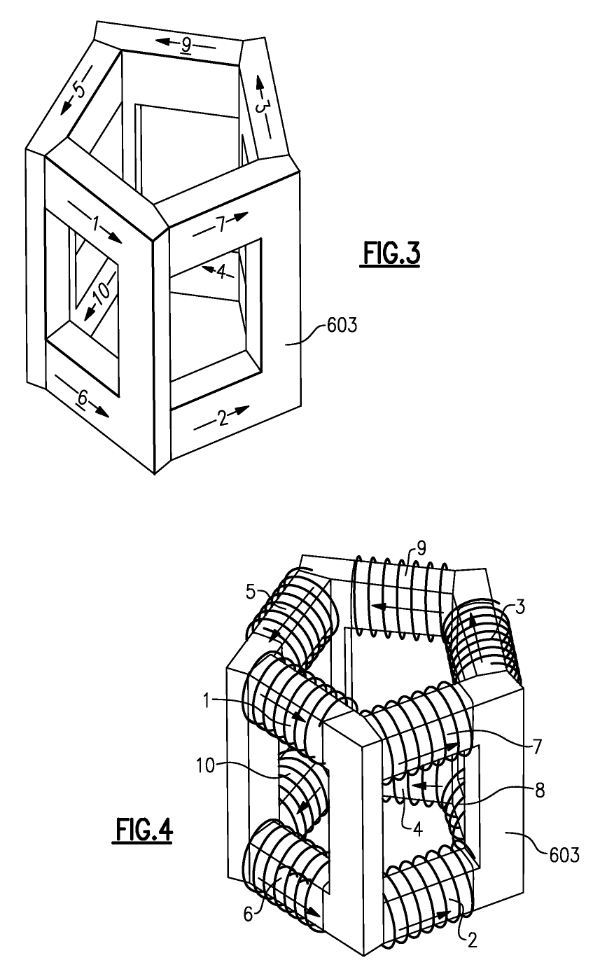

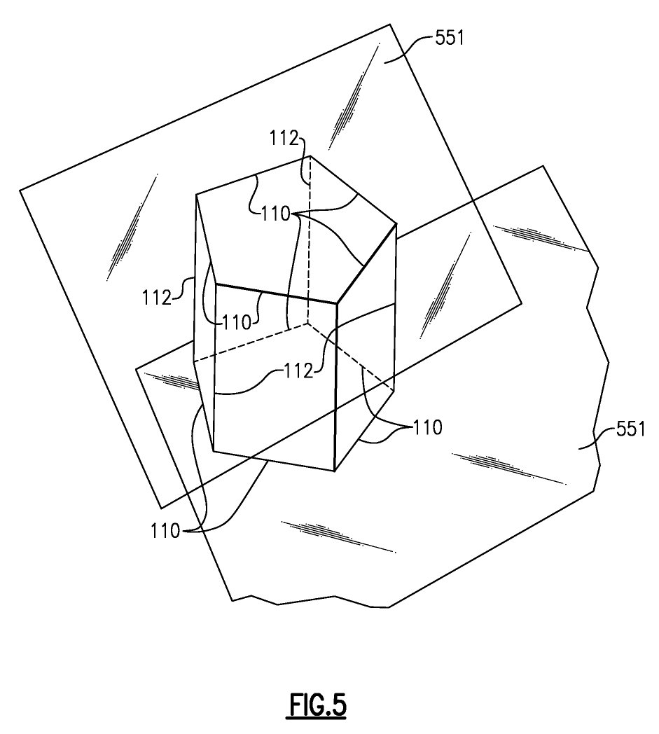

The invention generally pertains to a three dimensional “3D” poly-phase or polyhedron transformer having sides typically formed in the shape of polygons. FIG. 1 shows a perspective view of a simplified stick figure representing one exemplary embodiment of a 3D poly-phase transformer 100. The pentagon prism shaped transformer of FIG. 1 represents but one possible embodiment for a 3D poly-phase transformer 100. It is contemplated that many 3D poly-phase structures, including polyhedron as well as closed curve structures, preferably having an odd number of legs or ribs, can be used as the underlying structural shape for a 3D poly-phase transformer. FIG. 2 shows an illustration of one exemplary pentagon prism transformer core as represented by the stick diagram of FIG. 1. FIG. 3 illustrates an exemplary pentagon prism core made from core sections 603 also showing the magnetic flux path sequencing of FIG. 1. FIG. 4 shows another view of an exemplary pentagon prism transformer core including a symbolic representation of the transformer windings. The reference designators 1 to 10 of FIG. 4 correspond to the magnetic flux path sequencing of FIG. 1. The magnetic paths show the direction and path of magnetic flux induced in the core by one or more primary windings. For example, in a 10 phase 3D poly-phase transformer as shown in FIG. 4, the symbolic windings would generally be energized in the order shown to cause the magnetic flux to follow the number paths (although, in some specialized pulse applications, all primary windings can be energized simultaneously).

The term “polyhedron” as used herein is meant to include any N-sided prism. Exemplary polyhedron shapes believed suitable for a 3D poly-phase transformer include N sided prisms having an odd number of legs. It is also contemplated that other more complex polyhedron structures having an odd number of legs or ribs can provide suitable structure for a 3D poly-phase transformer. Transformer ribs are understood to have magnetic characteristics, such as a sufficient magnetic permeability at intended operating frequencies to allow creation of magnetic circuits within the 3D poly-phase transformer. While physically realizable and suitable for 3D poly-phase transformer use, more complex 3D structures can be costly to produce. Also, even sided structures, including cubes, are thought to be less suitable for a 3D poly-phase transformer because of a conflict in propagation of magnetic flux through the structure. Thus, the structure of a 3D poly-phase transformer can be of any type of geometric polyhedron having a pattern of any order. For example, a 3D “prism” structure (having triangular ends and square or rectangular sides, similar to the shape of an optical prism) is also thought to provide a suitable geometrical form for a 3D poly-phase transformer.

In one exemplary embodiment of a 3D poly-phase transformer 100 shown in FIG. 1 a primary winding and secondary winding can be wound on each numbered rib 101 (transformer coils, not shown in FIG. 1, are discussed in more detail below). Where the primary AC electrical voltages are staggered in phase, e.g. at 36 degree intervals, the 3D poly-phase transformer 100 can be used as a 10 phase poly-phase transformer. The numbers on the ribs 101 of stick diagram of FIG. 1 more clearly show one exemplary sequence of magnetic flux pattern. The arrows show the direction, such as South to North for a given portion of an AC cycle. Each rib 101 having a primary winding can be driven at a unique phase, typically at a phase that is substantially uniformly phase shifted from the other driving primary windings. Note that in the exemplary embodiment of FIG. 1, not all ribs 101 are driven by primary windings, as indicated by the absence of numbers on those ribs 101 not driven.

Other 3D poly-phase structures can also be used as the underlying structural shape for a 3D poly-phase transformer. One or more sides of a 3D structure can be closed curves other than polygon shapes having substantially straight sides or legs. Any closed curve, such as represented by the family of curves that can be developed, as for example from cylindrical or conic sections, can be used. Such curves can also be convex, concave, or any combination of convex or concave and can also include a plurality of substantially straight or partially curved sections including one or more zigzags. In one exemplary embodiment as shown in FIG. 8, two base planes of a 3D poly-phase transformer can be circles or ellipses separated by substantially straight legs. It is further contemplated that spherical or globe shapes can also be suitable to create a 3D poly-phase transformer.

As shown in FIG. 5, an exemplary pentagon prism 3D poly-phase transformer (similar to that represented by the stick diagram of FIG. 1) can include at least two “base” planes 551, each base plane 551 having a polygon, such as defined by a series of substantially straight connected lines or by a closed curve, such as a circle or ellipse, or any combination thereof. Ribs 101 of each base plane 551 polygon or closed curve are defined herein as base ribs 110. Disposed within a 3D poly-phase transformer and connecting the at least two planes are ribs 101 defined herein as side ribs 112. In embodiments having only two base planes, the side ribs 112 generally make contact at each end respectively of each side rib 112 with the polygon or closed curve in each of the two base planes 551. Base planes 551 typically, but not necessarily, include all of the primary and secondary transformer windings (electrical coils). In embodiments having additional base planes (more than two base planes), some side ribs 112 can connect the more than two planes and not all side ribs 112 will be mechanically connect to all planes. Also in some embodiments, side ribs 112, typically not including transformer windings, can also form polygons in a plane (other than a base plane), usually including at least two base ribs 110 (which do reside in a base plane). For example in FIG. 5, two side ribs 112 and two base ribs 110 form a square or rectangular polygon which is not a base plane.

In some embodiments, a 3D poly-phase transformer having base ribs in two or more bases, has a plurality of transformer ribs that are mechanically and magnetically coupled such that each transformer rib forms a leg of a polygon and a plurality of polygons forms a 3D polyhedron structure. At least two planes (i.e. base planes) of the 3D poly-phase transformer include a polygon, and each polygon in a base plane includes a plurality of base ribs. At least four side ribs of the 3D poly-phase transformer are disposed between the planes. In embodiments having only two base planes, each of the four side ribs makes mechanical contact at each end of each side rib with both polygons respectively of the two base planes. There are a plurality of primary transformer windings, each of the primary transformer windings electro-magnetically coupled to at least one rib of the plurality of transformer ribs and a plurality of secondary transformer windings, each of the secondary transformer windings electro-magnetically also coupled to at least one rib of the plurality of transformer ribs. Each of the primary transformer windings is configured to be powered by a phase of a primary poly-phase source of electrical power and each of the secondary transformer windings is configured to provide a secondary source of electrical power at a corresponding phase. In some embodiments, primary and secondary windings are wound only on the base ribs and not on the side ribs. Also, in some embodiments, both a primary and secondary winding can be wound on a common rib, most typically a base rib.

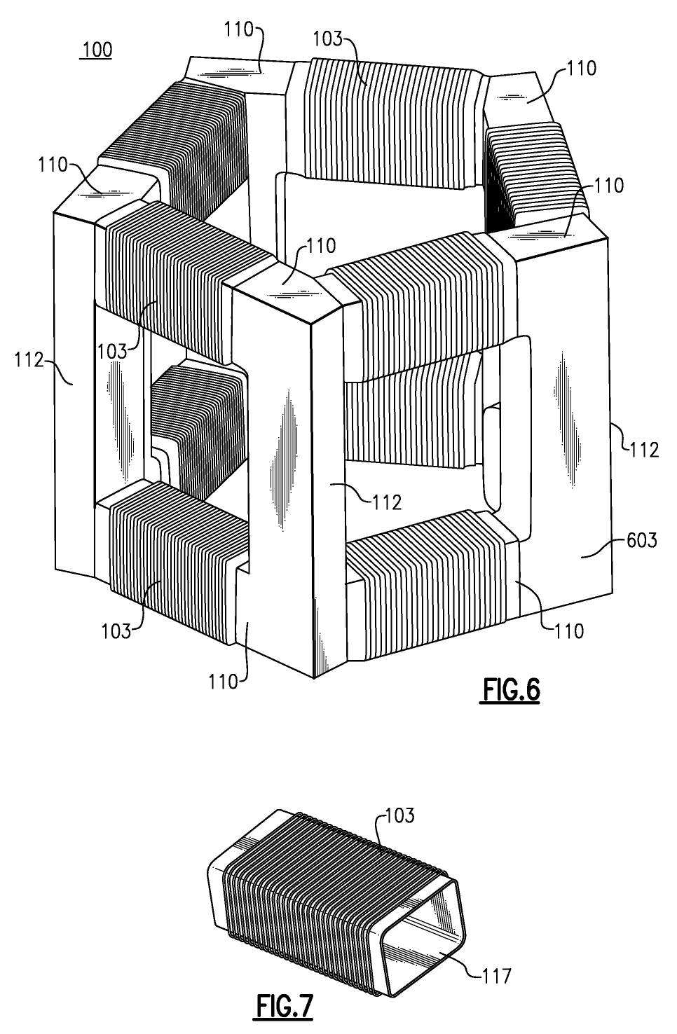

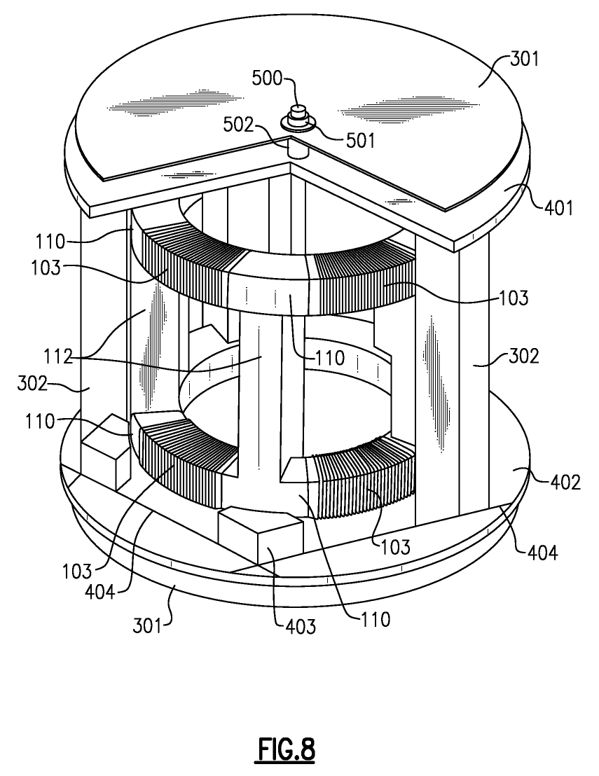

FIG. 6 shows one exemplary embodiment of a 3D poly-phase transformer having base ribs 110 in two base polygons. Five side ribs 112 make mechanical contact at each end of each side rib with both polygons respectively in the two base planes. Regarding the exemplary transformer windings, in this illustration, only the secondary windings 103 are visible as supported by a typically electrically insulating coil form 117, as also is illustrated in the more detailed coil illustration of FIG. 7. As is discussed in more detail below, it is unimportant whether a corresponding primary coil (not shown in FIG. 7) is wound underneath the secondary coil, side by side, or if the secondary coil is wound underneath the primary coil.

In other embodiments, a 3D poly-phase transformer has two or more base planes including a closed curve. A plurality of transformer ribs are mechanically and magnetically coupled to form a 3D structure that can include at least two planes in which each plane includes a closed curve. The closed curve includes a plurality of curved base ribs, and at least four side ribs of the 3D poly-phase transformer can be disposed between the at least two planes. A plurality of primary transformer windings can be electro-magnetically coupled to at least one rib of the plurality of magnetic transformer ribs, and a plurality of secondary transformer windings can be electro-magnetically coupled to at least one rib of the plurality of magnetic transformer ribs. Each of the primary transformer windings can be configured to be powered by a phase of a primary poly-phase source of electrical power and each of the secondary transformer windings can be configured to provide a secondary source of electrical power at a corresponding phase.

FIG. 8 shows an illustration of one exemplary embodiment of a 3D poly-phase transformer having base ribs 110 in two base circles (closed curves). Five side ribs 112 make mechanical contact at each end of each side rib with both circles respectively in the two base planes. In the illustration of FIG. 8, only the secondary windings 103 are visible. The components of the transformer mechanical housing (401, 402, 403, 500, 501, and 502) and associated electronic circuit boards (301, 302) are discussed below in more detail.

Thus it can be seen that a 3D poly-phase transformer can include polygon shapes having straight or curved lines, concave or convex polygons as well as closed curves in any combination thereof. For example, a 3D poly-phase transformer can include both a plane having a polygon with one or more substantially straight lines and another plane having a closed curve. Alternatively, there could be a plane having a mostly closed curve with one or more substantially straight sections.

Returning to FIG. 1, FIG. 3, and FIG. 4, it can now be seen that one suitable magnetic sequence pattern for a 3D poly-phase transformer is where the flux is switched alternately from a base rib in one base plane to a base rib in another base plane. Note that flux is typically directed into ribs as selected primary transformer windings are energized. For example in the pentagon prism 3D poly-phase transformer of FIG. 1, FIG. 3, and FIG. 4, it can be seen that a suitable magnetic sequence pattern for a 3D poly-phase transformer is where the flux is switched alternately from a base rib in one base plane to a base rib in the other base plane where on switching to each base plane, successive base ribs are magnetically energized on switching to each base plane. The term “successive ribs” is understood to mean a subsequent consecutive connecting base rib, in a common base plane, in a clockwise or counterclockwise rotation, around a particular polygon or closed curve. The magnetic sequence patterns described above are merely exemplary patterns. Other suitable magnetic sequence patterns can be used.

A 3D poly-phase transformer 100 can be viewed as equivalent to n stand alone transformers. There are several advantages combining the functionality of n transformers into a single 3D poly-phase transformer 100 electro-mechanical structure. Less core material is needed for a single n-phase 3D poly-phase transformer 100 as compared to the material that would be needed to fabricate n individual transformers. Also, core magnetic losses are proportional to inverse cube of the core mass as defined by the relation:

P_{L} ∝ k×V

in which: P_{L} is power loss measured in Watts, k is a loss coefficient measured in Watts per cm³, and V is the core volume, measured in cm³. Therefore, a 3D poly-phase transformer has less electrical loss than the equivalent n transformers. For example, a pentagon prism shaped 3D poly-phase transformer can replace the operation of 10 separate transformers with a substantially lower core volume and corresponding reduced power loss. In addition, a single 3D poly-phase transformer uses less physical space than the space equivalently used by the 10 single phase transformers of the example.

In general, there is an overall reduction of leakage inductance (L_{L}˜N²) of a 3D poly-phase transformer as compared to N equivalent stand alone transformers. However, another advantage of a 3D poly-phase transformer is that while the main magnetic path as described above follows the numbered path lines of FIG. 1, there is actually some flux field into adjacent ribs 101. It is contemplated that this leakage flux field can help drive each subsequent phase more efficiently though the magnetic hysteresis curve by pre-magnetizing the rib of the subsequent phase, thus causing a 3D poly-phase transformer 100 to be more electro-magnetically efficient than the n equivalent individual single phase transformers. Yet another advantage, described in more detail below, is that the 3D poly-phase transformer 100 structure is somewhat naturally demagnetizing, allowing each primary winding to be driven by a simple single ended driver as compared to conventional transformer drivers requiring a differential primary winding driver to avoid magnetization of a conventional transformer magnetic leg.

Ribs 101 of a 3D poly-phase transformer 100 can be fabricated from any suitable magnetic core material. At the very lowest suitable frequencies (e.g. 50 Hz to 500 Hz), conventional iron cores including laminated cores (for suppressing eddy currents) can be used. At slightly higher operating frequencies, alloys such as nickel-iron alloys (e.g. Permalloy) can be used. At frequencies of tens of kHz, typically materials having smaller magnetic domains can be used, such as amorphous metal materials. At frequencies of hundreds of kHz and above, ferrite materials can be used.

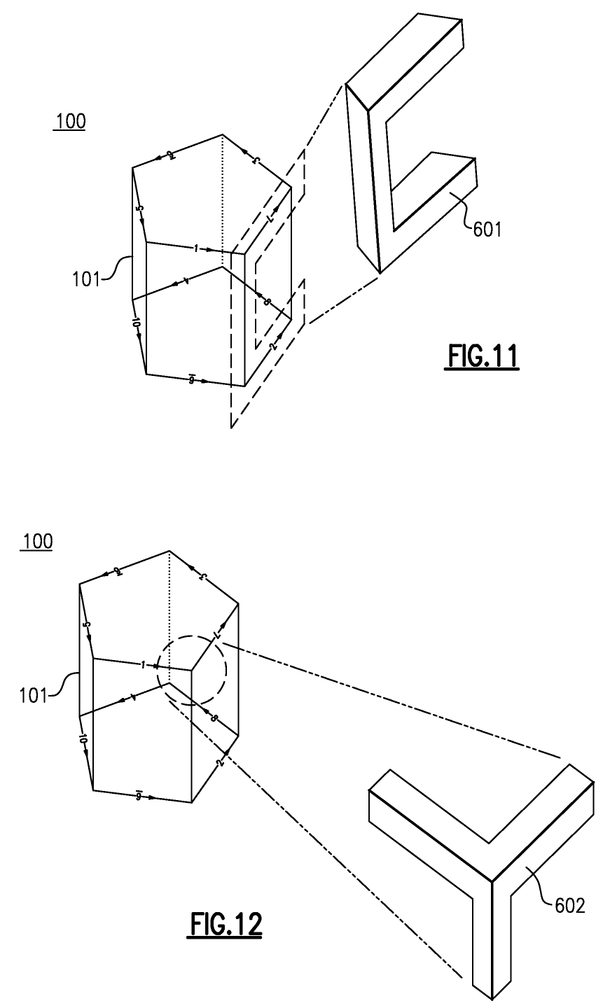

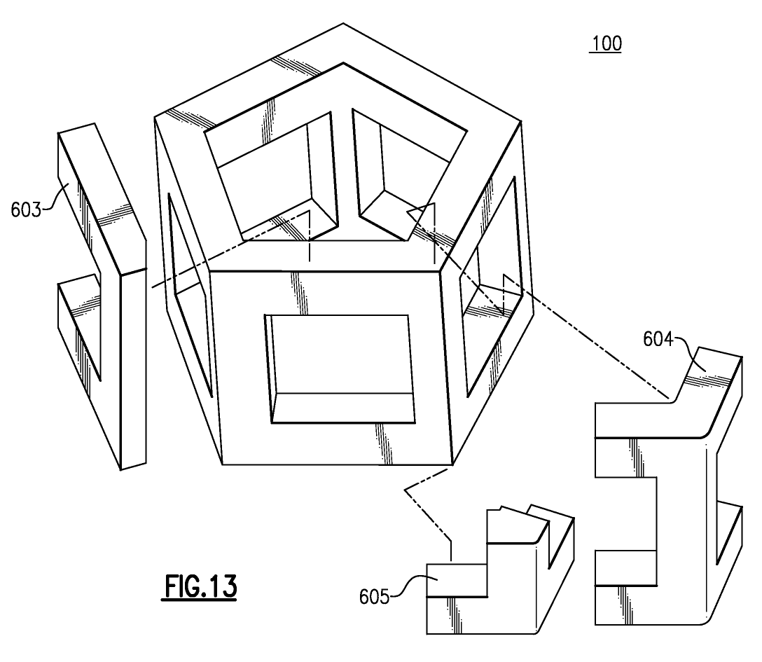

One advantage of moldable magnetic materials, such as ferrites, is that such materials can be molded at the time of manufacture to virtually any needed shape. In the case of the exemplary pentagon 3D poly-phase transformer core of FIG. 2, “U” shaped core sections 603 can, for example, be molded and joined as shown in FIG. 3 and FIG. 11. Alternatively, 3D polyhedron corner core sections 602 can be molded and joined as shown in FIG. 12. FIG. 13 shows another view of other suitable core sections 603, 604, and 605 that can be used to construct a pentagonal 3D poly-phase transformer. Such ferrite sections can be joined by mechanical means such as by straps or brackets. Ferrite sections can also be joined by a magnetic glue having similar magnetic properties (i.e. a magnetic permeability greater than 1) to the ferrite of the ribs 101. Such joining of ferrite sections can be done by mechanical means alone (e.g. straps and/or brackets), by glue or other suitable adhesive alone, or by some combination of glue or adhesive and mechanical means. Note that in the cases of FIG. 11, FIG. 12, and FIG. 13, bobbins or other suitable coil forms, such as plastic parts having pre-wound coils, can be conveniently slid over the sections during assembly.

A glue or adhesive used to join transformer 3D poly-phase transformer rib sections can be chosen to have desired magnetic properties. For example, the glue can be chosen to have magnetic properties similar to the rib material. Or, the glue can be used to intentionally introduce one or more different magnetic properties, such as to introduce a magnetic “gap”, such as to avoid saturation in lower frequency applications. Note, however, that a 3D poly-phase transformer generally does not require air gaps, due in part to the relatively long magnetic paths around the ribs.

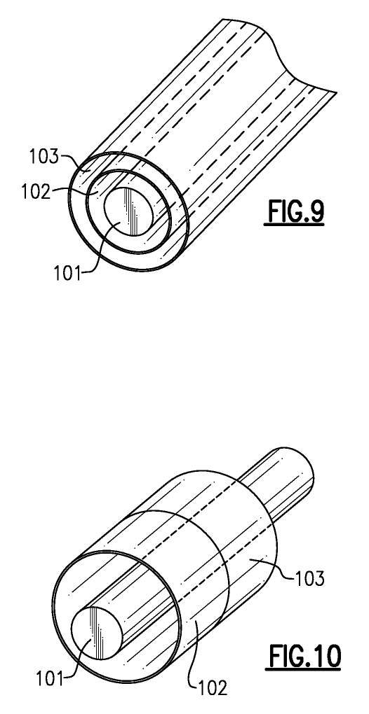

Electrical windings, shown symbolically as sheets in FIG. 9, can be placed using any known means of winding transformer coils. The winding method used and the physical type or style of each winding or windings on a bobbin form is unimportant to the invention. Typically, transformer bobbins can be fabricated from plastic, however any suitable material can be used. For example, where sections, such as shown in FIG. 9 or FIG. 10 are used, a pre-wound bobbin can be slipped on to each rib as the sections are joined. Any type of suitable conductor can be used to form both primary and secondary windings. At higher frequency operation, it can be desirable to use a Litz wire to add surface area due to skin effect considerations. One exemplary style for winding a primary and secondary winding on each rib 101 of a 3D poly-phase transformer 100 is shown in FIG. 9. It is generally unimportant to the invention whether the inner winding is the primary or secondary winding. Other suitable winding patterns include, for example, side by side primary and secondary windings on a rib 101 as shown in FIG. 10. It will be readily apparent that other winding patterns can be used.

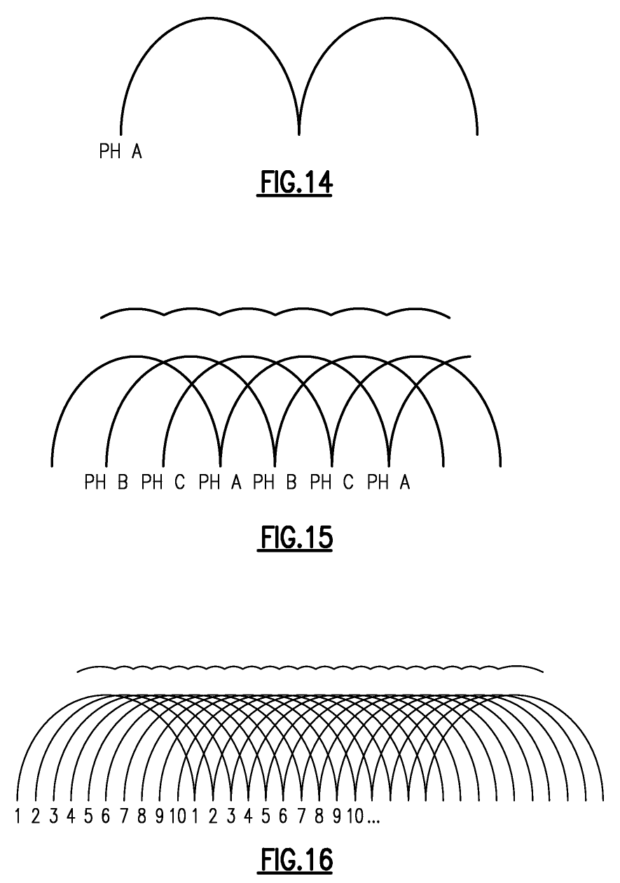

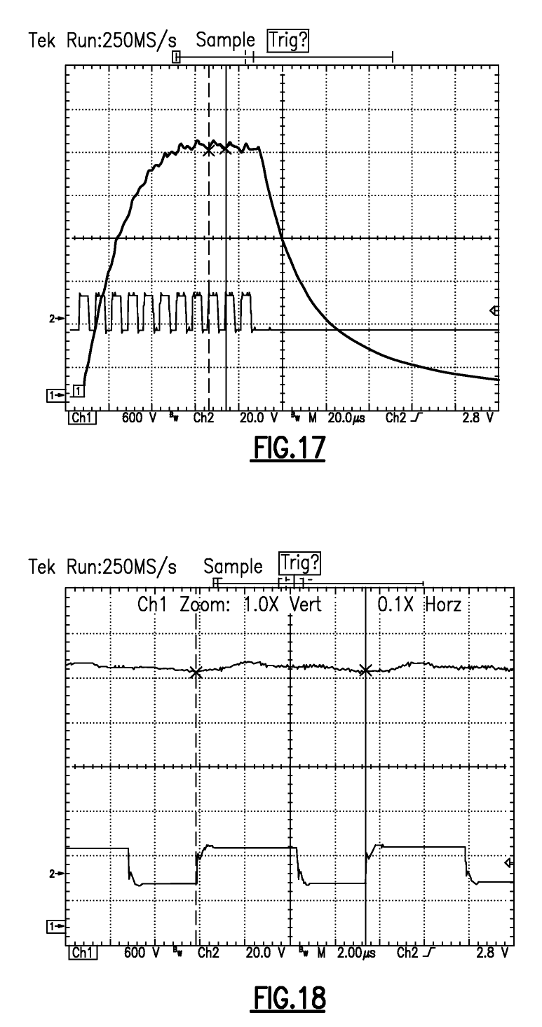

One advantage of multiphase AC power in AC to DC power conversion applications is that the resulting AC ripple component of the corresponding DC rectified output power becomes smaller as the number of phase increase and the corresponding output ripple frequency increases. For example, FIG. 14 illustrates a graph of a rectified single phase AC waveform. Note that the unfiltered rectified output voltage spans between zero volts and some peak value and for “full wave” rectification and that the output AC ripple has a frequency of twice the input AC voltage frequency. By contrast, the curves of FIG. 15 illustrate a three phase full wave rectified waveform. The lower curves of FIG. 15 show the effect of the overlapping rectified phases contributing to the actual resultant “6 pulse” un-filtered rectified waveform as illustrated by the upper curve in FIG. 15. Here, there is a far smaller swing in the output rectified voltage and the ripple is 360/6 or 60 degrees of phase of an individual phase of the input voltage AC period. For example, for a conventional 60 Hz input three phase input, the ripple frequency would be 360 Hz. As can be seen by the graph of FIG. 16 (a 10 phase system), as the number of phases is increased, the “raw” unfiltered ripple continues to be reduced.

The vast majority of DC power sources employ an output filter after rectification to further improve the quality of the output DC voltage. A filter can reduce the ripple resulting from either half wave or full wave rectification. In conditions where there is light loading on a power supply (low output current), the output DC voltage can be virtually ripple free with modestly sized filter components. The size of the filtering capacitors typically used in output filters is inversely proportional to the ripple frequency. Larger sized filter components, predominantly determined by the size of filter capacitors, can reduce ripple to acceptable levels for higher output loading conditions (higher output currents). At lower voltages, e.g. below 500V, capacitor technologies have advanced to where higher valued capacitors with sufficient voltage ratings are widely available and generally cost effective. However, lower capacitance values are still generally more economical. At higher voltages, the cost of higher valued capacitors can represent a significant part of the cost of the overall power supply. Filter capacitors can also occupy relatively large spaces thus inhibiting component and product miniaturization. Thus, for a given output voltage and output ripple requirement, the filter cost can be seen to be lower for a poly-phase power supply using lower filter capacitor values than for a corresponding single phase converter that requires higher values for filter components.

Another factor of interest in the design of power supply filters is the time constant of the filter. Filter capacitors operate by storing electrical energy. The stored energy is partially delivered to a load between each of the ripple peaks, thus mitigating the reduction in voltage at the load that would otherwise occur following each ripple peak. During continuous operation, for each ripple cycle, each filter capacitor is slightly charged and discharged, while maintaining an average DC output voltage. Generally larger values of capacitance, having longer time constants for a given electrical loading condition, provide lower AC ripple amplitude in the output voltage.

A competing interest, however, is the speed at which a power supply can be turned on or turned off. Some devices, such as RADARs, lasers, medical devices (e.g. Mammography, CT, Tomosynthesis, and Dual Energy X-Ray applications), and others, require narrow strobes (relatively narrow pulses or pulsed, for example, in a range of 1 to 100 us) of pulsed power or pulsed electromagnetic energy. Unfortunately, longer time constants, while desirable for reducing ripple amplitude, are undesirable with regard to on/off time. In fact, where relatively large output filter capacitors are present, often active switching components are needed to rapidly turn off the power supply. “Crow-bar” active discharge circuits have been used to literally “short circuit” a filter output, to rapidly discharge a large valued filter capacitance. Such active turn off techniques increase the complexity, cost and can reduce the useful life of the filter capacitors.

For a given desired ripple level, as the number of phases is increased, less capacitance is need in the output filter. The cost advantage of smaller valued filter capacitors is particularly important at high voltages, since high voltage capacitors are generally more expensive. Also, for applications needing faster power supply on/off times, lower valued filter capacitors associated with poly-phase rectification yield naturally lower time constants. The time constants can be short enough that in some cases active filter discharge techniques are no longer needed.

Power supply ripple amplitude is a function of the electrical values of the filtering components (generally larger valued capacitors correspond to lower ripple), the frequency of the primary AC voltage (higher frequencies can be more easily filtered and thus provide lower ripple), and the number of phases. Power supply ripple can be expressed as a percentage of a nominal DC output voltage:

R=[U−Uₘᵢₙ/U]*100%

in which: U represents the power supply nominal DC output voltage measured in Volts and Uₘᵢₙ represents the ripple trough, also measured in Volts.

The ripple level can also be affected by the accumulation of technical tolerances and the asymmetry in the phases of the line voltage. Typically, pre-filtered ripple is about 100% for single phase systems (single and two pulse power supplies, such as illustrated by FIG. 14), ˜25% for a six pulse system (FIG. 15) with a theoretical floor of 13.4%, ˜10% for a twelve pulse power supplies (FIG. 16) with a theoretical floor of 3.4%, and typically on the order of 4% for higher frequency power supplies.

Exemplary applications for a 3D poly-phase transformer include power supplies and x-ray power supplies (known in the industry and referred to herein interchangeably as x-ray generators). An x-ray generator for powering an x-ray source can includes a 3D poly-phase transformer where the 3D poly-phase transformer is configured to accept electrical power from a source electrical power. The x-ray generator also typically includes a rectifier circuit configured to rectify the secondary source of electrical power generated by the secondary transformer windings to generate an output voltage that powers the x-ray source. It is understood that the rectifier circuit can be based literally on rectifier diodes or be based on active circuitry such as actively driven switching devices, such as FETs (field effect transistor), MOSFETs (metal oxide field effect transistor), transistors, IGBTs (insulated gate field effect transistor), etc. (i.e. any electronic switch suitable for rectification at a desired operating frequency).

X-ray imaging of physiological structures (e.g. mammalian structures, including human physiology) is but one exemplary application that can particularly benefit from poly-phase rectification. X-ray imaging applications include, for example, heart studies, mammography, urology studies, radiography and fluoroscopy applications, especially those using rapid repeated x-ray exposures, such as for example, for placing a catheter. X-ray imaging uses at least one x-ray source, typically an x-ray tube. When a high voltage is applied to the x-ray tube, x-rays are emitted. One concern is to manage the spectrum of energy of the x-ray emission. There are several reasons to minimize the x-ray energy spectrum. One reason is that some lower energy exposure, below the desired imaging x-ray energy level, does not contribute to the image quality, but needlessly exposes that section of a patient's body to potentially harmful ionizing radiation. Another reason to limit the spectrum of emitted x-ray energies is that image quality can be optimized as the energy spectrum is made more optimal. For a given x-ray tube, the x-ray energy emission is a function of the applied high voltage. Therefore, any variation in applied high voltage, such as caused by power supply ripple, causes variation or spectrum in the energy of the x-ray emission.

### EXAMPLE 1

Mammography, CT, Tomosynthesis, and Dual Energy X-Ray Applications: For mammography applications and in particular for digital mammography, the variation of power needed to be delivered to an x-ray tube is typically between about 2 kW and 15 kW. For the reasons discussed above, it is desirable that there be a relatively low ripple level across the full dynamic range of the delivered power. Currently, typical ripple levels are in the range of 3% to 4%. Using the inventive poly-phase 3D transformer in a poly-phase power supply, it is believed that about 1% ripple voltage can be achieved. Digital mammography also demands very short kilovolt power supply “rise” and “fall” times. Generally, rise and fall times (power supply on-off times) of more than 1 msec negatively impact the digital detector performance and patient throughput (efficiency of the x-ray process as measured, for example, by the imaging time needed per patient). On/off switching times are particularly relevant in dual energy applications (e.g. 60 keV to image soft tissue and 120 keV to image bone structure) and tomosynthesis modes of operation.

X-ray systems as described herein are understood to include digital detector based imaging systems (typically including digital image processing), or film based imaging systems, using photographic processing, or a hybrid of the two (e.g. post photographic processing, digitization of one or more films, and digital image processing)

Controllable pulsed power supplies based on a poly-phase 3D transformer are particularly well suited to strobed or stroboscopic imaging of physiological structures. With the ability to generate well defined fast energetic pulses, imaging can be done with respect to a stimulus or trigger signal. A stimulus or trigger signal can be generated by a physiological parameter. For example, a beating heart study can include strobed images, such as images synchronized to signals from an electrocardiogram (ECG). Such images can be variably delayed in time from one or more physiological triggers to acquire images of different parts of the pumping cycle of the heart.

Another advantage of a poly-phase power supply using a poly-phase 3D transformer related to output voltage change with load power demand. Since there is small ripple on the output voltage having a closely spaced (relatively high frequency) ripple waveform using a poly-phase power supply based on a poly-phase 3D transformer, the ripple level effectively become independent of load current (power demand). This power independence is caused by a combination of the small change in voltage from ripple peak value to trough, combined with the relatively short interval before the next ripple wave “re-charges” the load, including any intervening cable capacitance.

Thus, advantages of low ripple in powering x-ray sources, such as x-ray tubes, include lower dosage to the patient, shorter exposure times, less kinetic blurring, and improved closed feedback loop performance.

Since the reproducibility and consistency of the high voltage, especially in fast voltage control systems, can have a substantial affect on x-ray image quality, high frequency generators having been developed such as have been described by Erich Krestel in Imaging Systems for Medical Diagnostics, Siemens Aktiengesellschaft, 1990. The ripple level (typically around 4%) depends both on the type of power supply, and the filtering capacitance in parallel to the x-ray tube. Prior art 3-phase power supplies (including 6-pulse and 12-pulse power supplies), typically operate at a standard mains line frequency of 50 or 60 Hz. Proper filtration therefore requires large size capacitors, which increases the size, weight, and cost of the power supply system. High frequency power supplies, operating at much higher frequencies, typically 10-100 kHz, have been typically 2-pulse systems providing pre-filtered rectified waveforms as shown in FIG. 14. Filtration of the higher frequency ripples are easier (e.g. using smaller valued filtered capacitors), however due to the absence of the phases overlapping, these prior art power supplies still requires substantially large valued filter components. In addition, the large amount of stored energy in a relatively large filter capacitor could be destructive in case of accidental release of that energy, e.g. an un-commanded x-ray tube arc.

### EXAMPLE 2

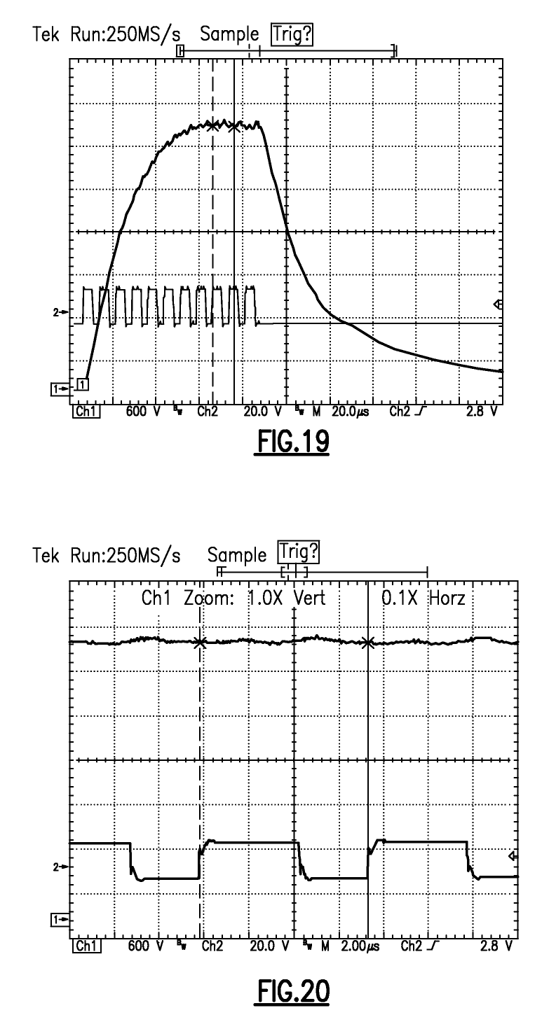

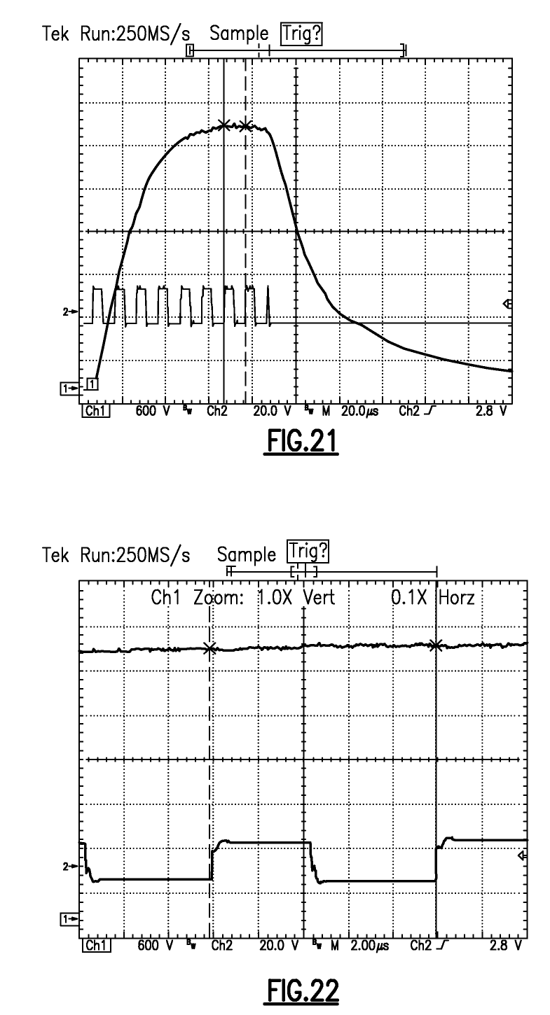

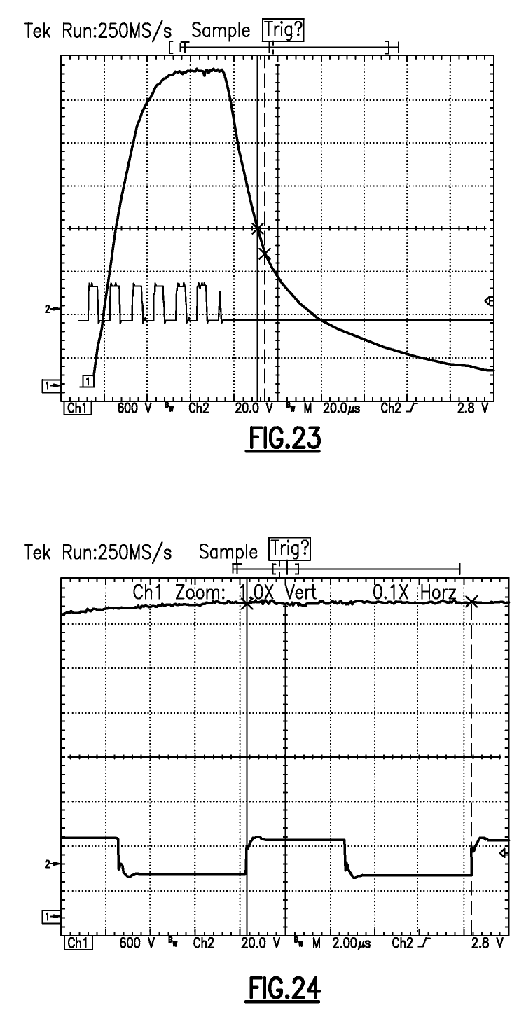

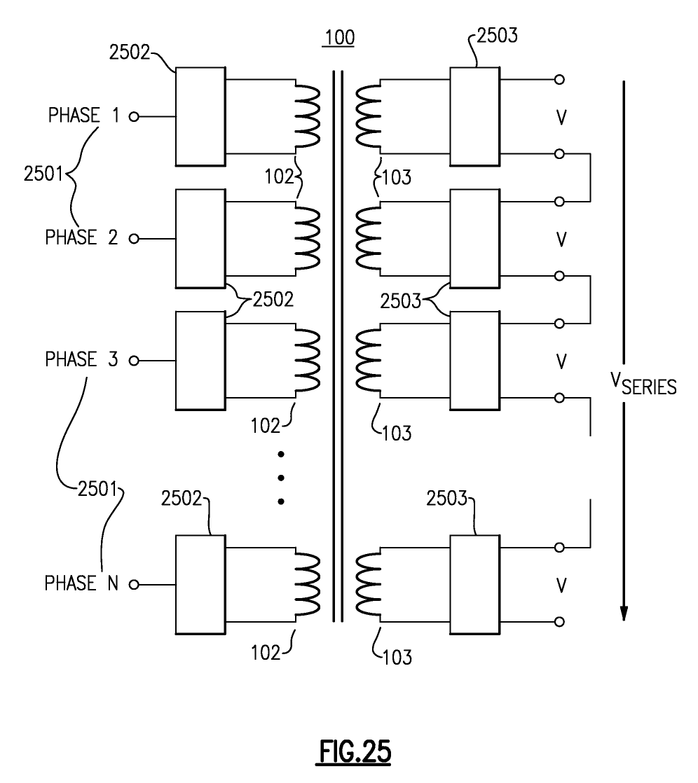

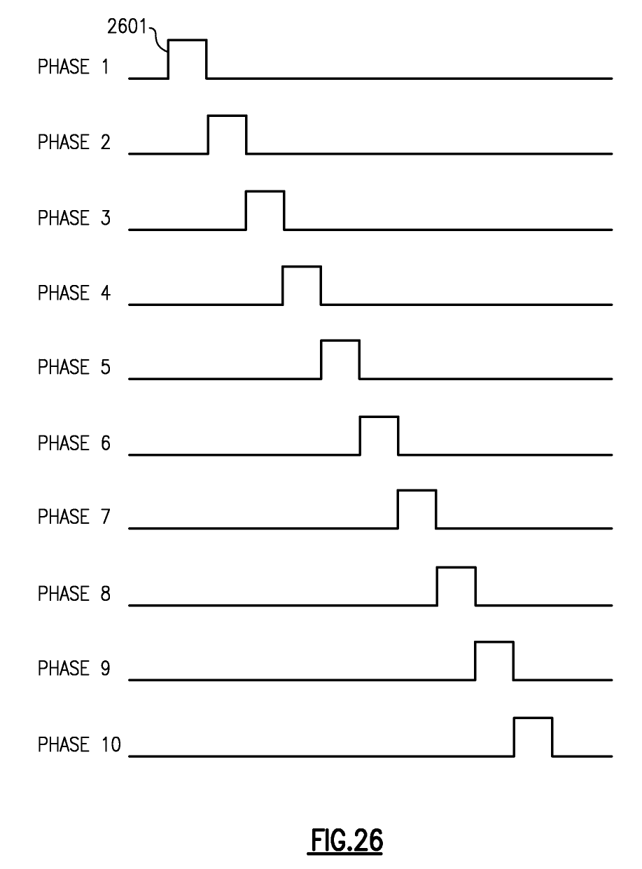

Testing of poly-phase power supply configurations was performed in the laboratory using poly-phase transformers. FIG. 17 shows an oscilloscope screen capture (oscillogram) of a kilovolt high voltage (HV) pulse produced using a two phase configuration. The HV pulse can be seen displayed on a horizontal scale of 20 μs/division and with a vertical scale of 600 V/division. The ripple at the flat top is perceptible. The smaller regular pulses of the lower trace represent the AC drive voltage. FIG. 18 shows a view of the oscillogram of FIG. 17 magnified in time (2 μs/division). The oscillogram of FIG. 19 shows a HV pulse generated using three phases. The flat top ripple can be seen to be improved over the two phase example, yet the ripple is still noticeable. FIG. 20 shows a magnified view of the oscillogram of FIG. 19. The oscillogram of FIG. 21 shows a HV pulse generated using four phases. The flat top ripple can be seen to be improved over the three phase example, yet again the ripple is still noticeable. FIG. 22 shows a magnified view of the oscillogram of FIG. 21. The oscillogram of FIG. 23 shows a HV pulse generated using eight phases. The flat top ripple can be seen to be improved over the four phase example to a point such that the ripple can no longer be seen on the oscillogram. FIG. 24 shows a magnified view of the oscillogram of FIG. 23 where again the ripple is to low to be seen in the oscillogram.

Another factor contributing to on/off speed is the capacitance of the HV cable connecting an x-ray tube to the high voltage power supply. Cable capacitance (typically ˜52 pF/ft) can play a significant role in the duration of the “tail” of the HV discharge and should be kept minimal. Shorter HV cable lengths can be achieved by using of a physically compact HV power supply packages that can be located closer to a respective x-ray tube load, such as an x-ray tube. The inventive poly-phase transformers are more compact and use less space allowing for a relatively small power supply package that can be placed closer to the x-ray tube.

FIG. 25 shows a block diagram of one exemplary embodiment of a power supply such as can be useful in medical x-ray imaging applications, using a 3D poly-phase transformer such as the 3D poly-phase transformer 100 shown in FIG. 1, FIG. 8, and FIG. 30. The generalized diagram shows N sets of primary windings 102 and secondary windings 103, typically wound on a common rib 101 (FIG. 1). For example, for the exemplary pentagon 3D poly-phase transformer 100 shown in FIG. 1, FIG. 8, and FIG. 30 the number of primary/secondary winding pairs can be 10. In one embodiment of such a power supply as shown in FIG. 25, there can also be N different phases. Typically, the N phases can be spaced apart by 360/N degrees. Thus, the time delay between phases (the phase shift) can be set by 360/N degrees for a given selected operating primary frequency. Generally, the operating frequency is relatively constant once selected at the time of power supply design, however, more advanced embodiments can also use variable frequencies. Each phase, generated by some source of periodic waveform, typically a relatively square pulse of suitable duty cycle, can be electrically coupled to a driver 2502 associated with each primary winding 102. Each phase then couples magnetically through each rib 101 of a 3D poly-phase transformer 100 to a corresponding secondary winding 103. A rectifier block 2503 rectifies each secondary phased output to create an output DC voltage V. There can be some filtering after rectification at the output of each rectifier block 2503 (not shown in FIG. 25), or further filtering can be done on an output voltage VSERIES created by series connection of the N rectified voltages V, or there can be DC filtering done both at each rectifier 2503 and following the series connected voltages. It is further understood that the turns ratio of the primary winding 102 relative to the secondary winding 103 can be any practically realizable ratio from less than 1, 1:1, or more commonly, greater than 1 (creating a higher voltage at the secondary winding than impressed on the corresponding primary winding). Rectifier block 2503 can also be replaced by an AC multiplier as known in the art. Multiplication can be two times each secondary voltage, or there can be multiplication by some higher factor than two, also as known in the art.

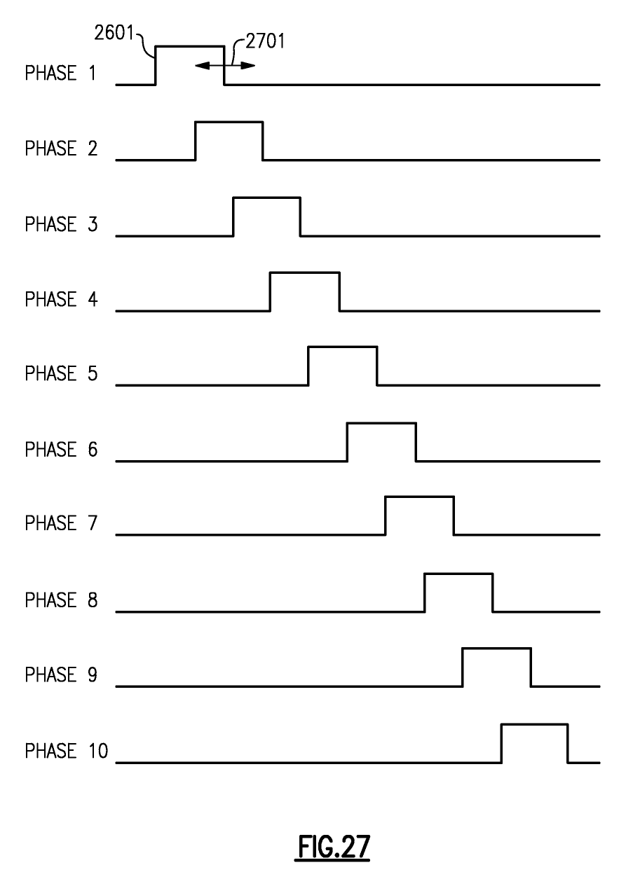

FIG. 26 shows one exemplary phase timing diagram of phases suitable for use to drive the exemplary power supply of FIG. 25. A series of phased waveforms are shown operating, for example, at 100 kHz. While pulses are shown in the exemplary phase timing diagram of FIG. 26, any suitable AC waveforms staggered in phase can be used. Leading edge 2601 of each pulse is staggered in phase from the previous phase by 360/10 or 36 degrees. One period (360° at 100 KHz) is 10 μs. Therefore 36° corresponds to 1 μs and thus each phase N is staggered from the previous phase N−1 by 1 μs. If full wave rectification for the rectifier blocks 2503 is assumed, the output ripple frequency at each phase (V) will have twice the primary ripple frequency, or a ripple frequency of 200 KHz. The total sum (superposition) of the 10 voltages V that are each staggered in phase, then can give an effective ripple frequency of 2 MHz for the 10 phase (20 pulse effective) system. There can be an additional improvement, for example when powering an x-ray tube, where there is a shift of phase in the anode and cathode circuits in relation to each other by about 18 degrees, the total of the ripple frequency will then double again, to 4 MHz. This type of further improvement in ripple (an increase in net ripple frequency) can be caused by out-of-phase superposition (effective addition) of the anode and cathode circuit power sources.

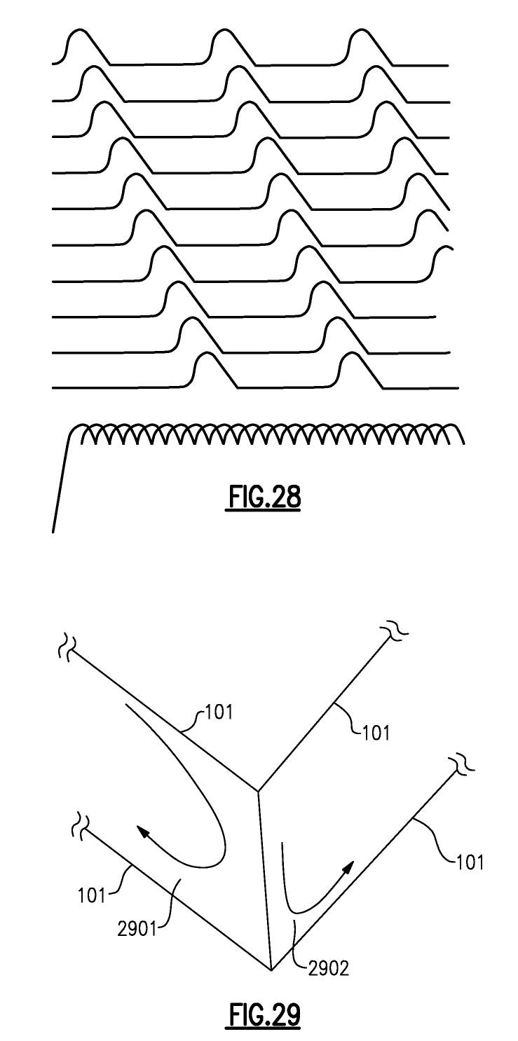

It is also contemplated that pulse width modulation (“PWM”) can be used to further control a 3D poly-phase based power supply. For example, PWM control can be introduced to the power supply of FIG. 25 by controlling the pulse width of each pulse, as shown in the exemplary phase timing diagram of FIG. 27. Pulse width can be varied in this embodiment by varying in time the location of each falling edge 2701. Note that the location in time of each leading edge 2601 remains substantially the same as in FIG. 26 to maintain proper timing for 10 pulse power supply converter operation. FIG. 28 illustrates one example of waveforms showing 10 individual phases of secondary side DC output ripple for each phase and the resultant combined low ripple (sum of the 10 DC phase voltages, bottom curve).

Also, note that in general, individual pulses of any suitable predetermined shape can be varied in duration and phase. For example, trapezoidal pulses can be suitable for some applications. It is also contemplated that pulses can be tailored in shape, repetition rate, phase, and/or period, over time to react to changing load conditions. For example, an initial load current surge can be satisfied by forcing initial phases to provide wider pulses (i.e. more energetic pulses).

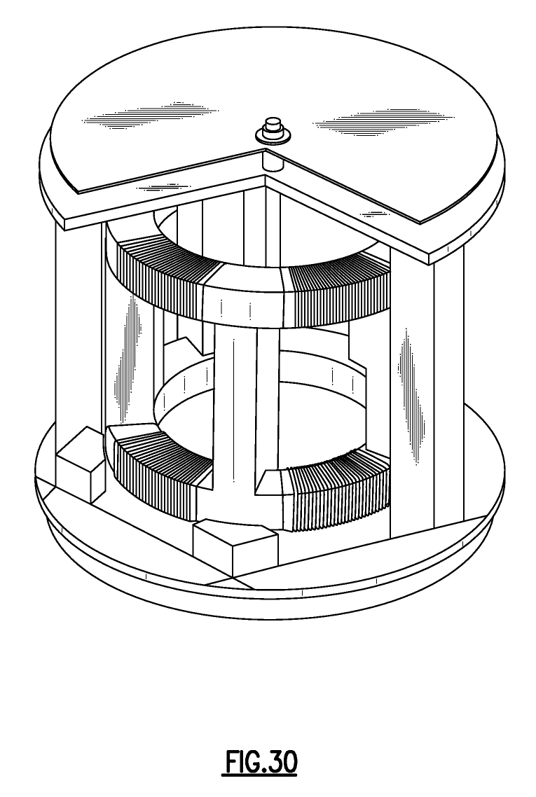

Another advantage of a 3D poly-phase transformer is that there can be leading magnetic flux in adjacent flux paths that can help the ribs cycle more quickly through their respective magnetic hysteresis curves. FIG. 29 illustrates one such exemplary leakage pattern having a leading magnetic flux 2902 in to an adjacent flux path 2901.

Individual HV coils are simplified in poly-phase transformers and leakage inductance is reduced as well. Less turns per coil are used in a poly-phase transformers as compared to “n-equivalent” transformers and leakage inductance is proportional to the number of turns squared. Therefore leakage inductance is reduced by use of a 3D poly-phase transformer.

The ribs of 3D poly-phase transformers also can provide a structure that is naturally or inherently de-magnetizing. Such de-magnetizing features allow for relatively simple primary driver circuitry, such as by driving the primary windings using simple single ended driver stages.

Returning to FIG. 8, one exemplary packaging technique is now discussed in more detail. As can been seen in FIG. 8, a 3D poly-phase transformer having two circular base planes is packaged between two circular covers 401 and 402. Slots 404 cut into covers 401 and 402 can accept circuit boards (e.g. printed circuit boards (PCB) 302), blank boards, and/or shielding panels (for magnetic and/or electrical shielding). Circuit boards 302 and/or suitable side plates disposed in slots 404 can provide support and spacing for covers 401 and 402. Covers 401 and 402 can be held in place, for example, by a central rod 500, spacer 502, and fastener 501. Additional circuit boards 301 can also be affixed near covers 401 and 402, such as by a central rod 500, spacer 502, and fastener 501. Circuit boards 301 and 302 can include components and circuits used to provide primary pulses to primary windings, control and/or triggering circuits to control the shape and/or timing of the primary pulses, secondary side rectifiers and filters, as well as any other electronic components that can be associated with a 3D poly-phase transformer based power supply. FIG. 30 shows an example of a polygon prism 3D poly-phase transformer packaged using a technique similar to the package shown in FIG. 8 (a 3D poly-phase transformer having two circular base planes). The packaging techniques described above are merely exemplary housing techniques. It is understood that other suitable packaging styles and techniques, including insulated or metal boxes, molded or machined covers, and/or suitable encapsulation or potting methods and materials can also be used in addition to or in place of the exemplary packages of FIG. 8 and FIG. 30.

In summary, the benefits of using a 3D poly-phase transformer in medical imaging applications that use x-ray tubes, because of the ability of the 3D poly-phase transformer power supply to provide relatively fast pulses, typically in a range of 1 μs to 100 μs, grid control x-ray tubes can be replaced by power supply pulsed methods. Also, with accurate fast power supply pulse control, crow bar discharge circuits are no longer needed. Pulsed waveform control available using a 3D poly-phase transformer power supply is compatible with advanced imaging modes, including, for example, tomosynthesis, dual energy, digital mammography, and cardiac CT. Increased ripple frequencies contribute to a higher quality x-ray radiation output (e.g. less energy spread), reduction in the size and weight of filter components, and reduction in EMI shielding. Moreover, efficient 3D poly-phase transformer power supply electronic compatible components include higher reliability, high longevity (high mean-time-between-failure “MTBF”) off-the-shelf components. Increased efficiency and MTBF also contributes to lower hardware support and maintenance costs.

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

While the present invention has been particularly shown and described with reference to the preferred mode as illustrated in the drawings, it will be understood by one skilled in the art that various changes in detail may be affected therein without departing from the spirit and scope of the invention as defined by the following claims.

We claim:

1. A three dimensional (3D) poly-phase transformer comprising:
a plurality of transformer ribs mechanically and magnetically coupled such that each transformer rib forms a leg of a polygon, wherein a plurality of said polygons forms a 3D polyhedron structure, at least two base planes of said 3D poly-phase transformer comprising a polygon having a plurality of base ribs, at least four side ribs of said 3D poly-phase transformer disposed between said base planes;
a plurality of primary transformer windings, each of said primary transformer windings electromagnetically coupled to at least one rib of said plurality of transformer ribs; and
a plurality of secondary transformer windings, each of said secondary transformer windings electromagnetically coupled to at least one rib of said plurality of transformer ribs,
wherein, each of said primary transformer windings is configured to be powered by a phase of a primary poly-phase source of electrical power and each of said secondary transformer windings is configured to provide a secondary source of electrical power at a corresponding phase.

2. The 3D poly-phase transformer of claim 1, wherein said 3D poly-phase transformer comprises an odd number of said transformer ribs.

3. The 3D poly-phase transformer of claim 1, wherein at least one of said at least two base planes of said 3D poly-phase transformer comprises an odd number of said base ribs.

4. The 3D poly-phase transformer of claim 3, wherein at least one of said polygons comprises a pentagon.

5. The 3D poly-phase transformer of claim 4, wherein said polyhedron structure comprises a pentagon prism.

6. The 3D poly-phase transformer of claim 1, wherein at least one of said side ribs comprises a substantially straight side rib.

7. The 3D poly-phase transformer of claim 1, wherein at least one of said side ribs comprises a curved side rib.

8. The 3D poly-phase transformer of claim 1, wherein said plurality of primary transformer windings and said plurality of secondary transformer windings are exclusively disposed on base ribs.

9. The 3D poly-phase transformer of claim 1, comprising three or more base planes, at least one of said three or more base planes comprising at least one curved section.

10. The 3D poly-phase transformer of claim 1, wherein said plurality of primary transformer windings are energized in a magnetic sequence pattern wherein a magnetic flux is alternately switched from a base rib in one of said at least two base planes to a base rib in another base plane.

11. The 3D poly-phase transformer of claim 10, wherein a successive base rib in a rotation direction is magnetically energized on switching to each base plane.

12. An x-ray imaging apparatus for imaging a physiological structure comprising:
an x-ray generator including a three dimensional 3D poly-phase transformer according to claim 1;
a source of x-rays powered by said x-ray generator and configured to transmit x-rays through said physiological structure;
at least one digital detector system configured to detect x-rays emerging from said physiological structure; and
a processor configured to receive an output signal from said at least one digital detector, wherein said output signal can be processed to generate imaging data representative of said physiological structure.

13. The x-ray imaging apparatus of claim 12, wherein said power supply comprises a pulsed power mode for stroboscopic imaging applications.

14. The x-ray imaging apparatus of claim 13, wherein said stroboscopic imaging comprising synchronization to a physiological parameter.

15. An x-ray imaging apparatus for imaging a physiological structure comprising:
an x-ray generator including a three dimensional 3D poly-phase transformer according to claim 1;
a source of x-rays powered by said x-ray generator and configured to transmit x-rays through said physiological structure; and
at least one film based detector system configured to detect x-rays emerging from said physiological structure, wherein said film can be photographically processed to generate imaging data representative of said physiological structure.

16. The x-ray imaging apparatus of claim 15, wherein said power supply comprises a pulsed power mode for stroboscopic imaging applications.

17. The x-ray imaging apparatus of claim 16, wherein said stroboscopic imaging comprising synchronization to a physiological parameter.

18. An x-ray generator for powering an x-ray source comprising:
a 3D poly-phase transformer according to claim 1, said 3D poly-phase transformer configured to accept electrical power from a source of poly-phase electrical power; and
a rectifier circuit configured to rectify said secondary source of electrical power generated by said secondary transformer windings to generate an output voltage,
wherein said output voltage powers said x-ray source.

19. A three dimensional 3D poly-phase transformer comprising:
a plurality of transformer ribs mechanically and magnetically coupled to form a 3D structure, at least two base planes of said 3D poly-phase transformer comprising a closed curve, said closed curve comprising a plurality of curved base ribs, and at least four side ribs of said 3D poly-phase transformer disposed between said base planes;
a plurality of primary transformer windings, each of said primary transformer windings electro-magnetically coupled to at least one rib of said plurality of magnetic transformer ribs; and
a plurality of secondary transformer windings, each of said secondary transformer windings electro-magnetically coupled to at least one rib of said plurality of magnetic transformer ribs,
wherein, each of said primary transformer windings is configured to be powered by a phase of a primary poly-phase source of electrical power and each of said secondary transformer windings is configured to provide a secondary source of electrical power at a corresponding phase.

20. The 3D poly-phase transformer of claim 19, wherein said closed curve of at least one of said at least two base planes comprises a circle.

21. The 3D poly-phase transformer of claim 19, wherein said closed curve of at least one of said at least two base planes comprises an ellipse.

22. The 3D poly-phase transformer of claim 19, wherein said 3D poly-phase transformer comprises an odd number of said transformer ribs.

23. The 3D poly-phase transformer of claim 19, wherein at least one of said at least two base planes of said 3D poly-phase transformer comprises an odd number of said transformer base ribs.

24. The 3D poly-phase transformer of claim 19, wherein said at least one side leg of said 3D poly-phase transformer comprises a substantially straight leg.

25. The 3D poly-phase transformer of claim 19, wherein said at least one side leg of said 3D poly-phase transformer comprises a curved leg.

26. The 3D poly-phase transformer of claim 19, comprising three or more base planes, at least one of said three or more base planes comprising at least one substantially straight section.

27. The 3D poly-phase transformer of claim 19, wherein said plurality of primary transformer windings are energized in a magnetic sequence pattern wherein a magnetic flux is alternately switched from a base rib in one of said at least two base planes to a base rib in another base plane.

28. The 3D poly-phase transformer of claim 27, wherein a successive base rib in a rotation direction is magnetically energized on switching to each base plane.

29. An x-ray imaging apparatus for imaging a physiological structure comprising:
an x-ray generator including a three dimensional 3D poly-phase transformer according to claim 19;
a source of x-rays powered by said x-ray generator and configured to transmit x-rays through said physiological structure;
at least one digital detector system configured to detect x-rays emerging from said physiological structure; and
a processor configured to receive an output signal from said at least one digital detector, wherein said output signal can be processed to generate imaging data representative of said physiological structure.

30. The x-ray imaging apparatus of claim 29, wherein said power supply comprises a pulsed power mode for stroboscopic imaging applications.

31. The x-ray imaging apparatus of claim 30, wherein said stroboscopic imaging comprising synchronization to a physiological parameter.

32. An x-ray imaging apparatus for imaging a physiological structure comprising:
an x-ray generator including a three dimensional 3D poly-phase transformer according to claim 19;
a source of x-rays powered by said x-ray generator and configured to transmit x-rays through said physiological structure; and
at least one film based detector system configured to detect x-rays emerging from said physiological structure, wherein said film can be photographically processed to generate imaging data representative of said physiological structure.

33. The x-ray imaging apparatus of claim 32, wherein said power supply comprises a pulsed power mode for stroboscopic imaging applications.

34. The x-ray imaging apparatus of claim 33, wherein said stroboscopic imaging comprising synchronization to a physiological parameter.

35. An x-ray generator for powering an x-ray source comprising:
a 3D poly-phase transformer according to claim 19, said 3D poly-phase transformer configured to accept electrical power from a source of electrical power; and
a rectifier circuit configured to rectify said secondary source of electrical power generated by said secondary transformer windings to generate an output voltage,
wherein said output voltage powers said x-ray source.

36. A method of manufacture of a three dimensional (3D) poly-phase transformer comprising the steps of:
forming a section of a polygon in a magnetic material;
placing primary and secondary windings on at least one rib of said formed section of a polygon; and
assembling said formed sections together to create a three 3D poly-phase transformer comprising at least two base planes having base ribs and at least 4 side ribs connecting said at least two base planes.

37. The method of claim 36, wherein said step of forming comprises forming by molding a section of a polygon in a magnetic material.

38. The method of claim 36, wherein said step of forming comprises forming a section of a polygon in a ferrite magnetic material.

39. The method of claim 36, wherein said step of assembling further comprises assembling said formed sections together by gluing.

40. The method of claim 39, wherein said step of assembling further comprises assembling said formed sections together by gluing using a glue having a magnetic permeability of greater than 1.

41. The method of claim 36, wherein said step of assembling further comprises assembling said formed sections together by mechanical straps.

42. The method of claim 36, wherein said step of assembling further comprises assembling said formed sections together by mechanical brackets.

43. The method of claim 36, wherein said step of placing comprises placing primary and secondary windings on at least one rib at least one wound bobbin.

44. A method of manufacture of a three dimensional (3D) poly-phase transformer comprising the steps of:
forming a section of a closed curve in a magnetic material;
placing primary and secondary windings on at least one rib of said formed section of a closed curve; and
assembling said formed sections together to create a 3D poly-phase transformer comprising at least two base planes having base ribs and at least 4 side ribs connecting said at least two base planes.

45. The method of claim 44, wherein said step of forming comprises forming by molding a section of a closed curve in a magnetic material.

46. The method of claim 44, wherein said step of forming comprises forming a section of a closed curve in a ferrite magnetic material.

47. The method of claim 44, wherein said step of assembling further comprises assembling said formed sections together by gluing.

48. The method of claim 47, wherein said step of assembling further comprises assembling said formed sections together by gluing using a glue having a magnetic permeability of greater than 1.

49. The method of claim 44, wherein said step of assembling further comprises assembling said formed sections together by mechanical straps.

50. The method of claim 44, wherein said step of assembling further comprises assembling said formed sections together by mechanical brackets.

51. The method of claim 44, wherein said step of placing comprises placing primary and secondary windings on at least one rib using at least one wound bobbin.
